(19) United States
(12) Patent Application Publication
(10) Pub. No.: US 2004/0123817 A1
(43) Pub. Date: Jul. 1, 2004

(54) Opposed internal combustion engine

(76) Inventor: Igor Olegovich Kiriljuk, Kharkov (UA)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/296,766

(22) PCT Filed: Jun. 13, 2001
(86) PCT No.: PCT/UA01/00016

(30) Foreign Application Priority Data
Jun. 15, 2000 (UA) 2000063495

(51) Int. Cl. F02B 57/00

(52) U.S. Cl. 123/44 R; 123/44 C

(57) ABSTRACT

The invention relates to engine building. The inventive opposed internal combustion engine comprises two cylinders (1, 2) fitted with pistons (10, 11) therein, a triple crank shaft (7) connected to the first piston (10) of the first connecting rod (19) with the aid of a pivot and connected to the second piston (11) with the aid of the second and third connecting rods (20, 21); the first and second crossheads (12, 13) are mounted on corresponding guides (3,4) in such a way that they form cavities (26) inside which the second and third connecting rods (20, 21) are connected to the pin (5) of the second crosshead (13). The invention decreases the inertial forces of an alternately moving mass and the gas pressure exerted on the pistons, subject to observance of the engine balance.

### BACKGROUND OF THE INVENTION

I. Field of the Invention

This invention relates to mechanical engineering, particularly to engine building. More particularly, the invention is directed to the designs of internal combustion engines with opposed cylinders balanced using no special mechanisms.

II. Description of the Prior Art

Internal combustion engines may be balanced in many ways such as by arranging its cylinders in a certain manner and choosing a crankshaft design so that the variable inertia forces and moments are counterbalanced; by creating new forces through use of additional masses that at any time are equal in magnitude but opposite in direction to the primary forces to be counterbalanced; or by combining both the first and second methods (see I. E. Lenin (ed.), Automobile and Tractor Engines. Part II, Moscow, Higher School, 1976, 34).

For instance, an opposed internal combustion engine is known which comprises a first cylinder and a second cylinder that are aligned and symmetric about the axis of its triple crankshaft. These first and second cylinders have first and second pistons, respectively, provided therein and pivotally connected to respective connecting rods. The first piston is connected to a first crankpin by a first connecting rod and the second piston is connected to a second crankpin and a third crankpin that is arranged symmetrically about the cylinder axis at 180 degrees with respect to the first crankpin by means of the second connecting rod. The second connecting rod is embodied as a forked connecting rod and straddles the first crankpin (DE 3132144 A1, date of publication: 03.03.83, Int. Cl. F16F15/24).

This known construction of opposed internal combustion engine is balanced not only with respect to rotating and reciprocating inertia forces as far as the first and higher degree moments of inertia which occurs due to axial displacement of the crankpins during engine operation.

A disadvantage of this known construction is that excessive loads are caused on the engine crank mechanism and bearings, by the remoteness of the second and third crankpins from the cylinder axis requiring the use of the second, forked connecting rod of large size and mass. A further disadvantageous feature of this prior art occurs when using cylinders of a diameter that is smaller than one required to accommodate the connecting rod fork in the cylinder. This requires connecting rods of more than twofold the length of those usually used thus resulting in even more increase in their mass. To ensure the engine balance, the first connecting rod should be made of a weight equal to that of the forked connecting rod causing it to be made heavier.

The increased rotating and reciprocating inertia forces causes loads on both the engine crank mechanism and bearings to increase as well. The accommodation of the connecting rod fork in the internal cylinder cavity results in an increase in the diameter of cylinders and, therefore, an increase in both the piston area and mass. This in turn results in an increase in the sum of forces caused by gas pressure on the piston and of reciprocating inertia forces acting on the engine crank mechanism and bearings.

A prototype of the engine in accordance with this invention is an opposed internal combustion engine, which comprises the first and second cylinders aligned and symmetric about the triple crankshaft axis. These first and second cylinders include the first and second pistons provided therein. The first, piston is associated with the first connecting rod which in turn is pivotally connected to the first crank. The second and third connecting rods, each being half the mass of the first connecting rod, are pivotally connected to the second and third cranks, respectively. The second and third crankpins are arranged symmetrically about the cylinder axis and are 180 degrees with respect to the first crankpin (EP 0503842 A1, date of publication: 05.03.92, Int. Cl. F02B 75/24, F01B 7/06, F02F 7/00).

In accordance with the invention, the second and third connecting rods are connected to the piston pin of the second piston in the internal cavity of the latter and the piston ring is fixed at its ends in the piston trunk walls.

In an internal combustion engine of the design according to the invention, the masses and inertia moments of rotating and reciprocating parts associated with the first and second cylinders are equal to each other and, thus, their mutual compensation during crankshaft rotation is ensured.

The remoteness of the second and third crankpin from the cylinder axis, and the necessity to locate the second rod, the third connecting rod in the internal cavity of the second pin requires the use of cylinders of a larger diameter thus resulting in an increase in both the mass and area of the pistons. In other words, an increase in both the reciprocating inertia forces and gas pressure forces on the piston results in an increase in the total forces acting on the engine crank mechanism and bearings.

Thus, an excessive load on the crank mechanism and bearings of the prior art opposed internal combustion engines which affected adversely both the engine reliability an MTTF is explained by that the measures taken to counterbalance the reciprocating and rotating inertia forces and moments that invariably resulted in an increase in the mass of the connecting rods or pistons.

III. Disclosure of the Invention

Broadly, it is an object of this invention to improve the performance of opposed internal combustion engine by providing a new design of crosshead mechanisms in order to achieve the result of a decrease in both reciprocating inertia forces and gas pressure forces on the pistons while maintaining the engine balance. This, in turn, contributes to a decrease in load on the engine crank mechanism and bearings and the improvement of engine reliability.

According to the present invention, an opposed internal combustion engine is provided comprising a first cylinder and a second cylinder aligned and symmetric about a triple crankshaft axis, said first and second cylinders having a first and a second piston, respectively, installed therein and first, second and third connecting rods corresponding thereto, said first connecting rods, each half the mass of the first connecting rod, are pivotally connected to second and third crankpins respectively; the second and third crankpins are arranged symmetrically about the cylinder axis and at 180 degrees with respect to the first crankpin. The engine is provided with first and second guides aligned with the cylinders and arranged symmetrically about the crankshaft axis. First and second crossheads are provided therein and connected to the respective pistons by means of stems and to the crankpins by means of connecting rods. The first crosshead is connected to the first crankpin by means of the first connecting rod that is pivotally connected to the pin of the first crosshead and the second crosshead is connected to the pin of the first crosshead and the second crosshead is connected to the second and third crankpins by means of the second and third connecting rods, respectively, with the latter being pivotally connected to the pin of the second crosshead.

According to this invention, the walls of each crosshead may be embodied with sections offset from the inner surface of guides associated therewith. These sections are symmetrically about the conventional plane crossing said crosshead along the cylinder axis normally to the hole axis of the crankpins. The ends of the crankpins protrude into cavities formed by the outer surface of the said crosshead and the inner surface of the respective guide.

The claimed aggregate of dominate features of the opposed internal combustion engine provides for a decrease in both reciprocating inertia forces and gas pressure forces on the pistons while maintaining the engine balance as compared with the said prototype. This is achieved through creating conditions for decreasing the diameter of cylinders as a consequence of connecting the pistons to connecting rods by means of stems and crossheads. This, in turn, obviates a need for having an interrelation between the dimensions required to accommodate the second and third connecting rods and the diameter of the respective piston.

The increased performance achieved by the preferred embodiment having crossheads with sections thereof offset from the inner surface of guides associated therewith. The embodiment further having the connection of the second and third connecting rods to the second crosshead pin ends that protrude into cavities formed by the outer surface of the second crosshead and the inner surface of the respective guide. This makes a possible decrease in both mass and area of the pistons, and thus, a decrease in the total forces acting on the crank mechanism which are the sum of gas pressure forces in the cylinders and reciprocating inertia forces (see I. E. Lenin (ed.), Automobile and Tractor Engines, Part II, Moscow, Higher School, 1976, 17-9).

A further advantage of the opposed internal combustion engine claimed is the unification of piston sets thereof which contributes not only to the engine balance but to manufacturability as well.

### IV. BRIEF DESCRIPTION OF THE DRAWING

A better understanding of the present invention will be had upon reference to the following detailed description when read in conjunction with the accompanying drawing wherein like reference characters refer to like parts in which:

FIG. 1/1 is a section of the opposed internal combustion engine along the cylinder axis.

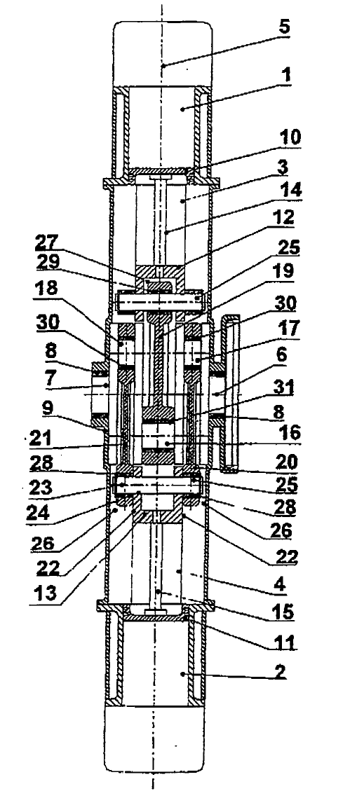

### V. PREFERRED EMBODIMENT OF THE PRESENT INVENTION

The inventive opposed internal combustion engine comprises a first and a second cylinder 1 and 2 respectively with guides 3 and 4 provided for therein. The guides are arranged in the cylinder axis 5 symmetrically about the axis 6 of the triple crankshaft 7. The crankshaft 7 is mounted in bearings 8 in the crankcase 9 of the engine. In the cylinders 1 and 2, there are installed pistons 10 and 11 respectively which are connected to crossheads 12 and 13 by means of stems 14 and 15 respectively. The crank mechanism of the engine comprises first, second and third crankpins 16, 17 and 18, and first, second and third connecting rods 19, 20, 21 respectively. The walls of the crossheads 12 and 13 preferably comprise sections 22 offset from the inner surface of the guides 3 and 4 associated therewith. The sections 22 are further arranged symmetrically about the conventional plane crossing the crossheads 12 and 13 along the cylinder axis 5 normally to the axis 23 of the holes 24 for pins 25. The ends of the pins 25 protrude into cavities 26 formed by the outer surface of the crossheads 12 and 13 and the inner surface of the guides 3 and 4 associated therewith. The connecting rods 19, 20 and 21 are pivotally connected to the crossheads 12 and 13 associated therewith by means of the pins 25 provided for in crosshead wall holes. The first crosshead 12 is connected to the first crankpin by means of the first connecting rod 19 which is connected to the pin 25 in the internal cavity 27 of the first crosshead 12. The second crosshead is connected to the second crankpin 17 by means of the second connecting rod 20 and to the third crankpin 18 by means of the third connecting rod 21. The connecting rods 20 and 21 are also connected to the ends of the pin 25. The connecting rods 19, 20 and 21 are connected to the pins 25 by means of bearings 28, 29, 30 and 31. The second and third crankpins 17 and 18 respectively are arranged symmetrically about the cylinder axis 5. The mass of each of the connecting rods 20 and 21 is half as much as that of the connecting rod 19.

### VI. INDUSTRIAL APPLICABILITY

During the operation of the inventive opposed internal combustion engine, the pistons 10 and 11, which take up gas pressure force in the cylinders 1 and 2, reciprocate along the cylinder axis 5 in the guides 3 and 4 respectively in the direction towards the axis 6 of the crankshaft 7 mounted in the bearings 8 in the engine crankcase 9. Reciprocating motion of the pistons 10 and 11 is transformed into rotational motion of the crankshaft 7 by means of the connecting rods 19, 20 and 21 connected to both the pistons 10 and 11 by means of the stems 14 and 15; and to the crossheads 12 and 13 by means of the pins 25 provided for in the holes 24 of the crosshead walls and to the respective crankpins 16, 17 and 18 of the crankshaft 7.

Whereas the centers of gravity of the connecting rod 19 and that of the connecting rods 20 and 21 are in the same plane and symmetric about the axis 6 of the crankshaft 7, and with a shift of 180 degrees of the revolution of the crankshaft 7, the rotating and reciprocating inertia forces of the connecting rods 19, 20 and 21 are counterbalanced.

The masses of the crosshead-piston sets are equal and the centers of gravity thereof are in the same axis which contributes to the balance of reciprocating inertia forces. At the same time, the sum of inertia forces on the crosshead-piston sets and gas pressure forces on the pistons is significantly less as compared with the prototype. This is due to an increase in their mass and head areas which causes loads on the engine crank mechanism and bearings (the bearings 8, 28, 29, 30 and 31) to decrease.

Having described my invention, many modifications thereto will become apparent to those skilled in the art to which it pertains without deviation from the spirit of the invention as defined by the scope of the appended claims.

I claim:

1. An opposed internal combustion engine comparing first and second cylinders (1, 2) that are aligned and symmetric about an axis (6) of a triple crankshaft (7), said first and second cylinders having first and second pistons (10, 11) installed therein; associated therewith is a first connecting rod (19) being pivotally connected to a first crankpin (16); and second and third connecting rods, (20, 21) and said second and third first connecting rod (19) being pivotally connected to second and third crankpins (17, 18) respectively, said second and third connecting rods being further arranged symmetrically about an axis (5) of the cylinders (1, 2) 180 degrees apart with respect to the first crankpin (16), wherein characterized in that the engine comprises first and second guides (3, 4) aligned with the cylinders (1, 2) and arranged symmetrically about said axis (6) of said crankshaft (7) with first and second crossheads (12, 13) provided therein and connected to pistons (10, 11) respectively by means of stems (14, 15) and to the crankpins (16, 17, 18) by means of crankpin (16) by means of the first connecting rod (19) pivotally connected to a first pin (25) of the first crosshead (12) and the second crosshead (13) being connected to the second and third crankpins (17, 18) be means of said second and third connecting rods (20, 21) respectively, and wherein said second and third connecting rods are pivotally connected to a second pin (25) of the second crosshead (13).

2. An opposed cylinder engine according to claim 1, wherein said crossheads further comprise walls, said walls having sections 22 offset from an inner surface of said guides (3, 4) and arranged symmetrically about the conventional plane crossing said crossheads (12, 13) along said axis (5) of the cylinders (1, 2) normally to an axis (23) of holes (24) for pins (25) wherein the ends of said pins (25) protrude into cavities (26) formed by an outer surface of crossheads (12, 13) and said inner surface of said guides (3, 4) associated therewith.

3. An opposed cylinder engine according to claim 2, wherein the first connecting rod (19) is connected to the said first pin (25) of the first crosshead (12) in an internal cavity (27) of the first crosshead (12) and the second and third connecting rods (20, 21) are connected to the ends of said second pin (25) of the second crosshead (13) that protrudes into said cavities (26) formed by said outer surface of the second crosshead (13) and the inner surface of the guide (4) associated therewith.
